(19) United States
(12) Patent Application Publication
(10) Pub. No.: US 2025/0013242 A1
(43) Pub. Date: Jan. 9, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventors: SHOJI MATSUDA, TOKYO (JP); HIROTAKA TANAKA, TOKYO (JP); TOMOHITO ODA, TOKYO (JP); KUNIAKI NODA, TOKYO (JP)

(21) Appl. No.: 18/699,904

(22) PCT Filed: Aug. 25, 2022
(86) PCT No.: PCT/JP2022/032009

§ 371 Date: Apr. 10, 2024

(30) Foreign Application Priority Data
Oct. 19, 2021 (JP) 2021-170693

(51) Int. Cl. G05D 1/248; G05D 1/686; G05D 109/20; G05D 111/10; G05D 111/50; G05D 111/67

(52) U.S. Cl. CPC G05D 1/248; G05D 1/686; G05D 2109/20; G05D 2111/17; G05D 2111/52; G05D 2111/67

(57) ABSTRACT

An information processing apparatus according to an embodiment of the present technology includes: a calculation unit. The calculation unit calculates a self-position of an own device that moves with a moving object, in accordance with a first movement state of a moving object and a second movement state of the own device, on a basis of first movement information relating to the moving object and second movement information relating to the own device. As a result, it is possible to improve detection accuracy. Further, it is possible to improve the accuracy and reliability of the self-position. Since no displacement of the self-position occurs even in a movement space, it is possible for a drone flying in the air to avoid collision with obstacles in the movement space.

### TECHNICAL FIELD

The present technology relates to an information processing apparatus, an information processing method, and a program that are applicable to control of automated movement, and the like.

### BACKGROUND ART

Patent Literature 1 describes an information processing apparatus that estimates, on the basis of sensing data provided by a plurality of sensors carried or worn by a user, the type of moving object on which the user is riding. In this information processing apparatus, information to be used in processing for determining the position of the user in the moving object is selected using the estimated type of moving object. As a result, it is possible to improve the accuracy of detecting the position in the moving object (paragraphs 0038 to 0053, FIGS. 3 and 4, and the like of the specification of Patent Literature 1).

### CITATION LIST

### Patent Literature

Patent Literature 1: Japanese Patent Application Laid-open No. 2017-67469

### DISCLOSURE OF INVENTION

### Technical Problem

There is a need for a technology capable of improving detection accuracy in such positioning using a sensor or the like.

In view of the circumstances as described above, it is an object of the present technology to provide an information processing apparatus, an information processing method, and a program that are capable of improving detection accuracy.

### Solution to Problem

In order to achieve the above-mentioned object, an information processing apparatus according to an embodiment of the present technology includes: a calculation unit.

The calculation unit calculates a self-position of an own device that moves with a moving object, in accordance with a first movement state of a moving object and a second movement state of the own device, on a basis of first movement information relating to the moving object and second movement information relating to the own device.

In this information processing apparatus, a self-position of an own device that moves with a moving object is calculated in accordance with a first movement state of a moving object and a second movement state of the own device, on a basis of first movement information relating to the moving object and second movement information relating to the own device. As a result, it is possible to improve detection accuracy. The first movement information may include a self-position of the moving object and a movement vector of the moving object. In this case, the second movement information may include the self-position of the own device and a movement vector of the own device.

The first movement state may include at least one of movement, rotation, or stopping of the moving object. In this case, the second movement state may include movement and stopping of the own device.

The calculation unit may calculate, in a case where the moving object is moving and the own device is stopped in contact with the moving object, the self-position of the own device by subtracting a movement vector of the moving object from a movement vector of the own device.

The first movement information may be acquired by an external sensor and an internal sensor mounted on the moving object. In this case, the second movement information may be acquired by an external sensor and an internal sensor mounted on the own device.

The own device may be a moving object capable of flight. In this case, the calculation unit may calculate, in a case where the moving object is moving and the own device is stopped in air, the self-position of the own device by adding or reducing weighting of the internal sensor mounted on the own device.

The external sensor may include at least one of a LiDAR (Light Detection and Ranging, Laser Imaging Detection and Ranging), a ToF (Time of Flight) camera, or a stereo camera.

The internal sensor may include at least one of an IMU (Inertial Measurement Unit) or a GPS (Global Positioning System).

The information processing apparatus may further include an imaging correction unit that controls, in a case where the own device is in contact with the moving object, the external sensor on the basis of a vibration system of the moving object and a vibration system of the own device.

The imaging correction unit may perform, in a case where a subject in contact with the moving object is imaged, control to match the vibration system of the moving object and the vibration system of the own device with each other.

An information processing method according to an embodiment of the present technology is an information processing method to be executed by a computer system, including: calculating a self-position of an own device that moves with a moving object, in accordance with a first movement state of a moving object and a second movement state of the own device, on a basis of first movement information relating to the moving object and second movement information relating to the own device.

A program according to an embodiment of the present technology causes a computer system to execute the following step of:
calculating a self-position of an own device that moves with a moving object, in accordance with a first movement state of a moving object and a second movement state of the own device, on a basis of first movement information relating to the moving object and second movement information relating to the own device.

### BRIEF DESCRIPTION OF DRAWINGS

FIG. 1 is a diagram schematically showing a movement space.

FIG. 2 is a block diagram showing a configuration example of a moving object and a robot.

FIG. 3 is a flowchart of self-position estimation of a robot.

FIG. 4 is a schematic diagram showing a robot that images the inside of a movement space of a moving object.

FIG. 5 is a block diagram showing an example of a hardware configuration of an information processing apparatus.

### MODE(S) FOR CARRYING OUT THE INVENTION

An embodiment of the present technology will be described below with reference to the drawings.

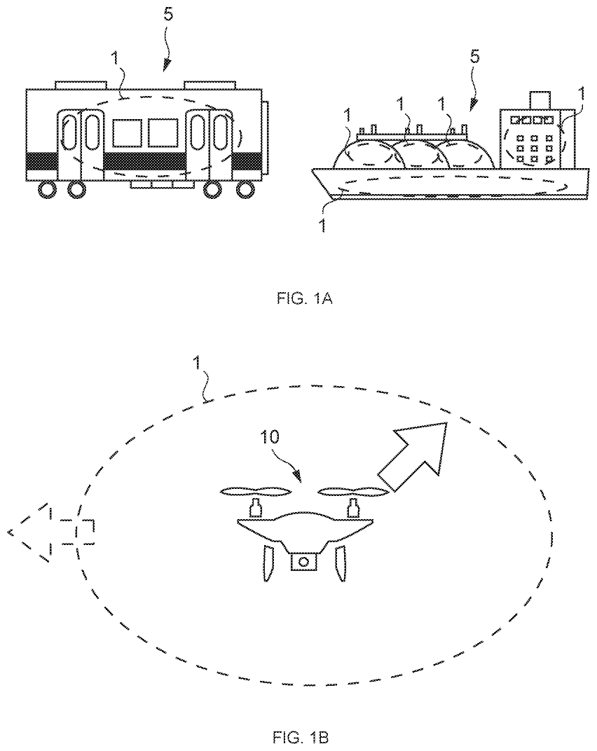

FIG. 1 is a diagram schematically showing a movement space. Part A of FIG. 1 is a schematic diagram showing a movement space. Part B of FIG. 1 is a schematic diagram showing a robot in a movement space.

In this embodiment, a robot 10 present inside a movement space 1 includes an external sensor and an internal sensor, and calculates a self-position of the robot 10. The self-position is a position of the robot 10 with respect to a map that is recognized or created by the robot 10.

As shown in Part A of FIG. 1, the movement space 1 is a space inside a moving object 5 that moves, such as a train and a ship. That is, the self-position, the movement vector, and the like of the movement space 1 change depending on the movement and rotation of the moving object.

Note that the number and range of the movement spaces 1 in the moving object 5 are not limited. For example, the inside of one train car may be used as a movement space, or each compartment (tank compartment) of a ship may be used as a movement space. Further, the area in which the robot 10 moves may be used as a movement space. For example, in the case of a robot capable of flight, a space a predetermined distance from the ground may be used as a movement space. Further, in the case of a robot travelling on the ground, a space within a predetermined distance from the ground, e.g., an area in which the robot is capable of travelling by itself, may be used as a movement space.

The robot 10 is an aircraft that is automatedly movable or operable such as a drone. In this embodiment, the robot 10 includes an external sensor and an internal sensor. Further, similarly, in this embodiment, the moving object 5 includes an external sensor and an internal sensor.

The external sensor is a sensor that detects information regarding the outside of the moving object 5 and the robot 10. For example, the external sensor includes a LiDAR (Light Detection and Ranging, Laser Imaging Detection and Ranging), a ToF (Time of Flight) camera, or a stereo camera.

The internal sensor includes a sensor that detects information regarding the inside of the moving object 5 and the robot 10. For example, the internal sensor includes an IMU (Inertial Measurement Unit) or a GPS (Global Positioning System).

Note that the sensor to be used as the external sensor and the internal sensor is not limited. For example, a depth sensor, a temperature sensor, an air pressure sensor, a laser ranging sensor, a contact sensor, an ultrasonic sensor, an encoder, or a gyro may be used.

As shown in Part B of FIG. 1, the robot 10 moves in the movement space 1. Typically, in the case where the moving object 5 is moving, if the estimation result of the self-position sensed from the IMU is used, it will not match the self-position of the robot 10 because the value due to the movement of the moving object 5 is included. Further, regarding the position relative to the moving object 5, the misrecognition of the self-position is not eliminated simply by sharing the self-positions of the moving object 5 and the robot 10.

In this embodiment, first movement information including the self-position and movement vector of the moving object 5 is supplied to the robot 10. The robot 10 calculates the self-position on the basis of the first movement information and second movement information including the self-position and movement vector of the robot 10. As a result, it is possible to improve the reliability of the self-position relative to an environment map.

Note that the movement vector refers to the direction, speed, and acceleration of parallel movement and rotation movement.

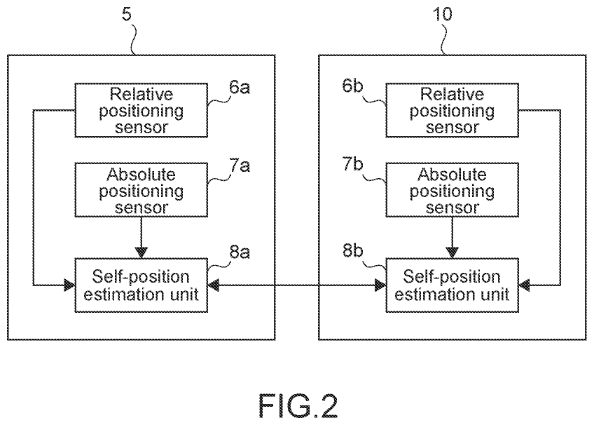

FIG. 2 is a block diagram showing a configuration example of the moving object 5 and the robot 10.

As shown in FIG. 2, the moving object 5 includes a relative positioning sensor 6a, an absolute positioning sensor 7a, and a self-position estimation unit 8a. The robot 10 includes a relative positioning sensor 6b, an absolute positioning sensor 7b, and a self-position estimation unit 8b.

The relative position is a position relative to the moving object 5. That is, even when the moving object 5 moves, the relative position does not change. In this embodiment, the self-position to be acquired by an external sensor such as a LIDAR is referred to as the relative position.

The absolute position is a position relative to the earth (ground). That is, when the moving object 5 (movement space 1) moves, the absolute position changes. In this embodiment, the self-position to be acquired by an internal sensor such as an IMU and a GPS is referred to as the absolute position.

The relative positioning sensor 6a (6b) acquires information relating to the relative position with respect to the outside. For example, the relative positioning sensor 6a (6b) includes a LiDAR, a ToF camera, a stereo camera, or the like, and acquires external sensor information such as a distance (positional relationship) and relative speed to a specific object. In this embodiment, external sensor information of the moving object 5 and the robot 10 is acquired by SLAM (Simultaneous Localization and Mapping) using an imaging apparatus such as a camera. The external sensor information acquired by the relative positioning sensor 6a (6b) is supplied to the self-position estimation unit 8a (8b).

Hereinafter, the SLAM using an imaging apparatus will be referred to as a VSLAM (Visual SLAM).

The absolute positioning sensor 7a (7b) acquires information regarding the inside of the moving object 5 and the robot 10. For example, the absolute positioning sensor 7a (7b) acquires internal sensor information such as the speed, acceleration, and angular velocity of the moving object 5 and the robot 10. Further, the acquired internal sensor information of the moving object 5 and the robot 10 is supplied to the self-position estimation unit 8a (8b).

The self-position estimation unit 8a (8b) estimates the self-positions of the moving object 5 and the robot 10 on the basis of the external sensor information and the internal sensor information. In this embodiment, the self-position estimation unit 8b weights the external sensor and the internal sensor in accordance with the movement state of the moving object 5 (first movement state) and the movement state of the robot 10 (second movement state).

The first movement state includes at least one of movement, rotation, or stopping of the moving object 5. The second movement state refers to a state where the robot 10 is moving and the robot 10 is stopped. In this embodiment, the movement states of the moving object 5 and the robot 10 are classified into the following conditions.

The moving object 5 is moving and the robot 10 is moving (condition 1).

The moving object 5 is moving and the robot 10 remains stationary in the air (condition 2A).

The moving object 5 is moving and the robot 10 remains stationary on the ground (in contact with the moving object 5) (the condition 2B).

The moving object 5 is stopped and the robot 10 is moving (condition 3).

The moving object 5 is stopped and the robot 10 is stopped (condition 4).

The self-position estimation unit 8b determines the current movement states of the moving object 5 and the robot 10 on the basis of the external sensor information and the internal sensor information. For example, the amount of movement of the robot 10 is determined from the internal sensor information acquired from the IMU.

Further, for example, in the case of the condition 2A, the self-position estimation unit 8b reduces the weighting of the IMU of sensor fusion processing or adds weighting of the VSLAM. Further, in the case of the condition 2B, the self-position estimation unit 8b estimates the self-position by subtracting the movement vector of the moving object 5 from the movement vector of the robot 10.

That is, the self-position estimation unit 8b estimates the self-position by switching between correcting the positioning result of the VSLAM and using the result of the IMU in accordance with each condition.

Note that as the relative positioning sensor 6a (6b) and the absolute positioning sensor 7a (7b) to be mounted on the moving object 5 and the robot 10, different sensors may be used.

Note that in this embodiment, the self-position estimation unit 8b corresponds to a calculation unit that calculates a self-position of an own device that moves with a moving object, in accordance with a first movement state of a moving object and a second movement state of the own device, on a basis of first movement information relating to the moving object and second movement information relating to the own device.

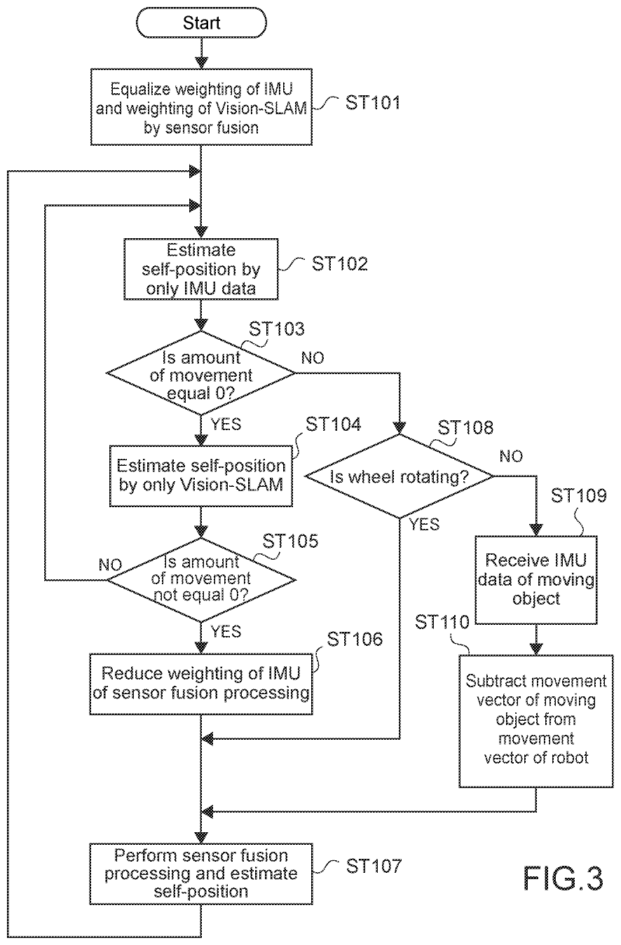

FIG. 3 is a flowchart of self-position estimation of the robot 10.

As shown in FIG. 3, the weighting of the IMU and the weighting of the VSLAM are equalized by sensor fusion (Step 101).

The self-position estimation unit 8b estimates the self-position of the robot 10 from the internal sensor information acquired from the IMU (Step 102). For example, the self-position estimation unit 8b estimates the self-position using dead reckoning or the like, which integrates minute changes in the internal sensor such as an encoder (angle sensor of a motor, etc.) and a gyro, such as the position and posture (orientation) of the robot 10, from the initial state.

The self-position estimation unit 8b determines whether or not the amount of movement of the robot 10 is zero from the IMU data (Step 103).

In the case where the amount of movement of the robot 10 is zero (YES in Step 103), the condition 2A or the condition 4 is assumed. In this case, the self-position estimation unit 8b estimates the self-position of the robot 10 from the external sensor information acquired from the VSLAM (Step 104). For example, the self-position estimation unit 8b estimates the self-position using star reckoning or the like, which measures the position of a known landmark on the map using the VSLAM to measure the current position of the robot 10.

The self-position estimation unit 8b determines whether or not the amount of movement acquired from the VSLAM is zero (Step 105).

In the case where the amount of movement is zero (YES in Step 105), the condition 2A is assumed. In this case, the self-position estimation unit 8b reduces the weighting of the IMU of sensor fusion processing or adds the weighting of the VSLAM (Step 106).

The self-position estimation unit 8b performs sensor fusion processing and estimates the self-position of the robot 10 (Step 107).

In the case where the amount of movement is not zero (NO in Step 105), the condition 4 is assumed. In this case, the processing returns to Step 102.

Returning to Step 103, in the case where the amount of movement of the robot 10 is not zero (NO in Step 103), the condition 1, the condition 2B, or the condition 3 is assumed. In this case, the self-position estimation unit 8b determines whether or not a wheel (encoder) of the robot 10 is rotating (Step 108).

In the case where the wheel is rotating (YES in Step 108), the condition 1 or the condition 3 is assumed. In this case, the self-position estimation unit 8b performs the processing of Step 107.

In the case where the wheel is not rotating (NO in Step 108), the condition 2B is assumed. In this case, the self-position estimation unit 8b receives the IMU data of the moving object 5 from the self-position estimation unit 8a (Step 109).

The self-position estimation unit 8b subtracts the movement vector of the moving object 5 from the movement vector of the robot 10 (Step 110). After that, the self-position estimation unit 8b performs sensor fusion processing and estimates the self-position of the robot 10 (Step 107).

As described above, the robot 10 according to this embodiment calculates the self-position of the robot 10 that moves with the moving object 5, in accordance with the first movement state of the moving object 5 and the second movement state of the robot 10, on the basis of the first movement information relating to the moving object 5 and the second movement information relating to the robot 10. As a result, it is possible to improve detection accuracy.

In the past, in the case where SLAM is performed on the self-position of a robot moving in a vehicle such as a ship and a train using nearby geometric information or a field-of-view information, it will be displaced from information indicating the absolute position of an IMU, a GPS, and the like. Further, in the case of a robot floating in the air, such as a drone, there is a possibility that the robot will collide with a wall when performing positioning using dead reckoning, because the IMU does not respond.

If an external sensor such as a camera is used to perform correction in order to avoid these problems, when the vehicle moves, the self-position is influenced by its surroundings and moves even through the robot itself is stationary.

In the present technology, the priority of the positioning sensor between the absolute coordinate system and the local coordinate system is automatically switched in accordance with the movement states of the moving object and the robot.

As a result, it is possible to improve the accuracy and reliability of the self-position. Since no displacement of the self-position occurs even in a movement space, it is possible for a drone flying in the air to avoid collision with obstacles in the movement space. Further, it is possible to prevent the self-position from being lost even in a crowded crowd. Further, since even the inside of a moving ship can be inspected by a drone, it is possible to reduce the time and cost of berthing for inspection.

### OTHER EMBODIMENTS

The present technology is not limited to the embodiment described above, and various other embodiments can be realized.

In the above embodiment, the self-position of the robot 10 has been estimated in accordance with the movement state of the moving object 5. The present technology is not limited thereto, and a camera mounted on the robot 10 may be controlled.

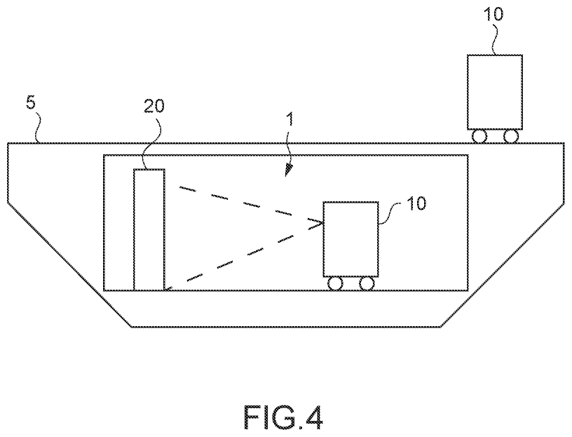

FIG. 4 is a schematic diagram showing a robot that images the inside of the movement space 1 of the moving object 5.

In FIG. 4, the moving object 5 that generates vibration along with movement, such as a ship and a train, is taken as an example. Further, the robot 10 includes a wheel and a camera and is capable of travelling and imaging a subject 20. That is, the robot 10 is affected by vibration other than vibration caused by the travelling of the robot 10 itself along with the vibration of the moving object 5.

In the case where the robot 10 images a subject (not shown) outside the moving object 5, gimbal and shake correction of the camera are performed on the basis of the internal sensor information acquired from the IMU mounted on the robot 10. Conversely, in the case where the robot is inside the moving object 5 (inside the movement space 1), the shaken subject 20 is imaged when the vibration of the moving object 5 is removed to image the subject 20.

In this embodiment, the robot 10 includes an imaging correction unit that matches a vibration system of the subject 20 (vibration system of the moving object) and a vibration system of the robot 10 with each other.

The imaging correction unit determines, on the basis of the external sensor information and the internal sensor information acquired from the relative positioning sensor 6b and the absolute positioning sensor 7b, whether or not the subject 20 and the robot 10 are present in the movement space 1. Further, in the case where the robot 10 is present in the movement space 1, the imaging correction unit performs control to match the vibration system of the subject 20 and the vibration system of the robot 10 with each other.

In the above embodiment, the self-position has been estimated in the movement space of the moving object such as a ship and a train. The present technology is not limited thereto, and the robot 10 may be used for various purposes and have a configuration necessary for the purpose. For example, the robot may be an aircraft intended for in-vehicle sales, such as Shinkansen and an airplane. In this case, the robot may include a detection unit that performs detection processing, recognition processing, and tracking processing of obstacles around the robot, and detection processing of the distance to the obstacles. As a result, it is possible to save labor and reduce the risk of infection.

Further, for example, the robot 10 may be an aircraft intended for patrolling inside a building that includes an escalator or the like. That is, by accurately estimating the self-position, the robot is capable of moving to places that cannot be reached by the robot itself by using machines with driving capabilities such as escalators other than the robot. For example, even in situations where the environment map changes significantly, e.g., the robot transfers from a station platform to a train, it is possible to accurately estimate the self-position.

In the above embodiment, the movement information has included a self-position and a movement vector. The present technology is not limited thereto, and the movement information may include various types of information of a moving object and a robot. For example, the movement information may include a current value of a rotor used in a propeller or the like, a voltage value of a rotor, or a rotation speed value of an ESC (Electric Speed Controller). Further, the movement information may include information regarding movement obstruction. For example, the movement information may include information regarding obstacles present in the movement direction of the robot or disturbance information such as wind.

In the above embodiment, the first movement information has been acquired by the external sensor and the internal sensor mounted on the moving object 5. The present technology is not limited thereto, and the first movement information may be acquired by an arbitrary method.

In the above embodiment, the self-position estimation unit 8a (8b) has been mounted on the moving object 5 and the robot 10. The present technology is not limited thereto, and a self-position estimation unit may be mounted on an external information processing apparatus. For example, the information processing apparatus includes an acquisition unit that acquires first movement information of a moving object and second movement information of a robot. The self-position estimation unit estimates the self-positions of the moving object 5 and the robot 10 in accordance with the first movement state and the second movement state, on the basis of the acquired first movement information and second movement information. In addition to this, the information processing apparatus may include a determination unit that determines a first movement state and a second movement state on the basis of sensor information acquired by the relative positioning sensor 6a (6b) and the absolute positioning sensor 7a (7b).

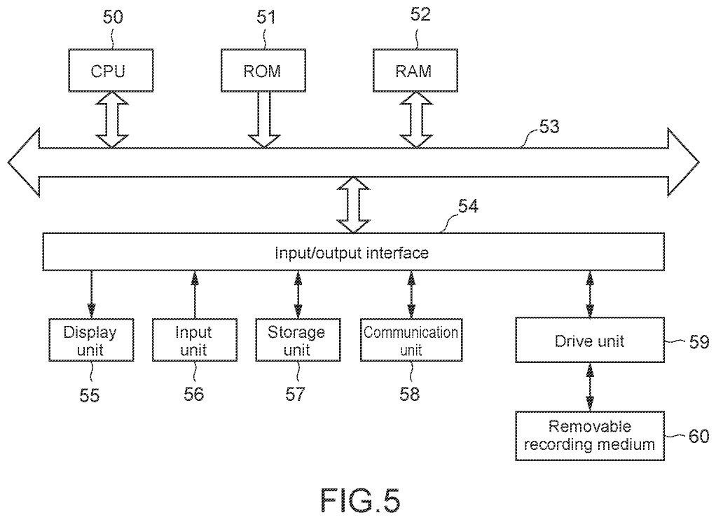

FIG. 5 is a block diagram showing an example of a hardware configuration of an information processing apparatus.

The information processing apparatus includes a CPU50, a ROM 51, a RAM 52, an input/output interface 54, and a bus 53 that connects these to each other. A display unit 55, an input unit 56, a storage unit 57, a communication unit 58, a drive unit 59, and the like are connected to the input/output interface 54.

The display unit 55 is, for example, a display device using liquid crystal EL, or the like. The input unit 56 is, for example, a keyboard, a pointing device, a touch panel, or another operating device. In the case where the input unit 56 includes a touch panel, the touch panel can be integrated with the display unit 55.

The storage unit 57 is a non-volatile storage device and is, for example, an HDD, a flash memory, or another solid-state memory. The drive unit 59 is, for example, a device capable of driving a removable recording medium 60 such as an optical recording medium and a magnetic recording tape.

The communication unit 58 is a modem, a router, or another communication device for communicating with another device, which can be connected to a LAN, a WAN, or the like. The communication unit 58 may perform communication using either wired or wireless communication. The communication unit 58 is often used separately from the information processing apparatus.

In this embodiment, the communication unit 58 enables communication with another apparatus via a network.

The information processing by the information processing apparatus having the above hardware configuration is realized by cooperation between software stored in the storage unit 57, the ROM 51, or the like and hardware resources of the information processing apparatus. Specifically, the control method according to the present technology is realized by loading a program constituting software, which is stored in the ROM 51 or the like, into the RAM 52 and executes the program.

The program is installed in the information processing apparatus via, for example, the recording medium 60. Alternatively, the program may be installed in the information processing apparatus via a global network. In addition, an arbitrary computer-readable non-transitory storage medium may be used.

The information processing method and the program according to the present technology may be executed and the signal processing unit according to the present technology may be constructed by linking a computer mounted on a communication terminal with another computer capable of communicating with the computer via a network.

That is, the information processing apparatus, the information processing method, and the program according to the present technology can be executed not only in a computer system configured by a single computer but also in a computer system in which a plurality of computers operates in conjunction with each other. Note that in the present disclosure, the system refers to a collection of a plurality of components (such as apparatuses and modules (parts)) and it does not matter whether all of the components are in a single housing. Therefore, both a plurality of apparatuses housed in separate casings and connected to each other through a network and a single apparatus in which a plurality of modules is housed in a single casing correspond to the system.

Execution of the information processing apparatus, the information processing method, and the program according to the present technology by the computer system includes, for example, both a case where estimation of a self-position is executed by a single computer and a case where each process is executed by different computers. Further, execution of each type of processing by a predetermined computer includes causing another computer to execute part or all of the processing and acquiring the result thereof.

That is, the information processing apparatus, the information processing method, and the program according to the present technology are applicable also to a configuration of cloud computing in which a plurality of apparatuses shares and collaboratively processes a single function via a network. Note that the effects described in the present disclosure are merely illustrative and not restrictive, and other effects may be achieved. The above description of the plurality of effects does not necessarily mean that these effects are exhibited simultaneously. It means that at least one of the effects described above can be achieved in accordance with the condition or the like, and it goes without saying that there is a possibility that an effect that is not described in the present disclosure is exhibited.

Of the characteristic portions of each embodiment described above, at least two characteristic portions can be combined with each other. That is, the various characteristic portions described in the respective embodiments may be arbitrarily combined with each other without distinguishing from each other in the respective embodiments.

It should be noted that the present technology may also take the following configurations.
(1) An information processing apparatus, including:
   a calculation unit that calculates a self-position of an own device that moves with a moving object, in accordance with a first movement state of a moving object and a second movement state of the own device, on a basis of first movement information relating to the moving object and second movement information relating to the own device.
(2) The information processing apparatus according to (1), in which
   the first movement information includes a self-position of the moving object and a movement vector of the moving object, and
   the second movement information includes the self-position of the own device and a movement vector of the own device.
(3) The information processing apparatus according to (1), in which
   the first movement state includes at least one of movement, rotation, or stopping of the moving object, and
   the second movement state includes movement and stopping of the own device.
(4) The information processing apparatus according to (3), in which
   the calculation unit calculates, in a case where the moving object is moving and the own device is stopped in contact with the moving object, the self-position of the own device by subtracting a movement vector of the moving object from a movement vector of the own device.
(5) The information processing apparatus according to (1), in which
   the first movement information is acquired by an external sensor and an internal sensor mounted on the moving object, and
   the second movement information is acquired by an external sensor and an internal sensor mounted on the own device.
(6) The information processing apparatus according to (5), in which
   the own device is a moving object capable of flight, and
   the calculation unit calculates, in a case where the moving object is moving and the own device is stopped in air, the self-position of the own device by adding or reducing weighting of the internal sensor mounted on the own device.
(7) The information processing apparatus according to (5), in which
   the external sensor includes at least one of a LiDAR (Light Detection and Ranging, Laser Imaging Detection and Ranging), a ToF (Time of Flight) camera, or a stereo camera.
(8) The information processing apparatus according to (5), in which
   the internal sensor includes at least one of an IMU (Inertial Measurement Unit) or a GPS (Global Positioning System).
(9) The information processing apparatus according to (7), further including
   an imaging correction unit that controls, in a case where the own device is in contact with the moving object, the external sensor on a basis of a vibration system of the moving object and a vibration system of the own device.
(10) The information processing apparatus according to (9), in which
   the imaging correction unit performs, in a case where a subject in contact with the moving object is imaged, control to match the vibration system of the moving object and the vibration system of the own device with each other.
(11) An information processing method for a computer system to execute the step of:
   calculating a self-position of an own device that moves with a moving object, in accordance with a first movement state of a moving object and a second movement state of the own device, on a basis of first movement information relating to the moving object and second movement information relating to the own device.
(12) A program that causes a computer system to execute the step of:
   calculating a self-position of an own device that moves with a moving object, in accordance with a first movement state of a moving object and a second movement state of the own device, on a basis of first movement information relating to the moving object and second movement information relating to the own device.

### REFERENCE SIGNS LIST

1 movement space
5 moving object
8 self-position estimation unit
10 robot
20 subject

1. An information processing apparatus, comprising:
a calculation unit that calculates a self-position of an own device that moves with a moving object, in accordance with a first movement state of a moving object and a second movement state of the own device, on a basis of first movement information relating to the moving object and second movement information relating to the own device.

2. The information processing apparatus according to claim 1, wherein
the first movement information includes a self-position of the moving object and a movement vector of the moving object, and
the second movement information includes the self-position of the own device and a movement vector of the own device.

3. The information processing apparatus according to claim 1, wherein
the first movement state includes at least one of movement, rotation, or stopping of the moving object, and
the second movement state includes movement and stopping of the own device.

4. The information processing apparatus according to claim 3, wherein
the calculation unit calculates, in a case where the moving object is moving and the own device is stopped in contact with the moving object, the self-position of the own device by subtracting a movement vector of the moving object from a movement vector of the own device.

5. The information processing apparatus according to claim 1, wherein
the first movement information is acquired by an external sensor and an internal sensor mounted on the moving object, and
the second movement information is acquired by an external sensor and an internal sensor mounted on the own device.

6. The information processing apparatus according to claim 5, wherein
the own device is a moving object capable of flight, and
the calculation unit calculates, in a case where the moving object is moving and the own device is stopped in air, the self-position of the own device by adding or reducing weighting of the internal sensor mounted on the own device.

7. The information processing apparatus according to claim 5, wherein
the external sensor includes at least one of a LiDAR (Light Detection and Ranging, Laser Imaging Detection and Ranging), a ToF (Time of Flight) camera, or a stereo camera.

8. The information processing apparatus according to claim 5, wherein
the internal sensor includes at least one of an IMU (Inertial Measurement Unit) or a GPS (Global Positioning System).

9. The information processing apparatus according to claim 7, further comprising
an imaging correction unit that controls, in a case where the own device is in contact with the moving object, the external sensor on a basis of a vibration system of the moving object and a vibration system of the own device.

10. The information processing apparatus according to claim 9, wherein
the imaging correction unit performs, in a case where a subject in contact with the moving object is imaged, control to match the vibration system of the moving object and the vibration system of the own device with each other.

11. An information processing method for a computer system to execute the step of:
calculating a self-position of an own device that moves with a moving object, in accordance with a first movement state of a moving object and a second movement state of the own device, on a basis of first movement information relating to the moving object and second movement information relating to the own device.

12. A program that causes a computer system to execute the step of:
calculating a self-position of an own device that moves with a moving object, in accordance with a first movement state of a moving object and a second movement state of the own device, on a basis of first movement information relating to the moving object and second movement information relating to the own device.
